(19) United States
(12) Patent Application Publication
(10) Pub. No.: US 2010/0200479 A1
(43) Pub. Date: Aug. 12, 2010

(54) MOLTEN PLASTIC MATERIAL FILTRATION APPARATUS

(75) Inventor: Chia-Chang YANG, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: ROYAL STEEL PLASTIC TECHNOLOGY INDUSTRIAL CO., LTD.,, Shalu Township (TW)

(21) Appl. No.: 12/540,460

(22) Filed: Aug. 13, 2009

(30) Foreign Application Priority Data
Feb. 11, 2009 (CN) 200910008877.4

(51) Int. Cl. B01D 33/50; B01D 33/70; B01D 33/29; B01D 33/46

(52) U.S. Cl. 210/149; 210/391; 210/392; 210/236; 210/385

(57) ABSTRACT

A molten plastic material filtration apparatus includes a shell, which has a cavity, and a feed channel, an outfeed channel and a cleaning channel respectively disposed in communication between the cavity and the space outside the shell, a filter mounted in the cavity of the shell and rotatable relative to the shell and having a filter chamber and a plurality of through holes cut through the periphery thereof in communication with the filter chamber, a guide member affixed to the shell and positioned in the filter chamber of the filter, the guide member having a feed-in guide passage, a cleaning guide passage and an outfeed guide passage corresponding to the feed channel, cleaning channel and outfeed channel of the shell, a scraper mounted in the cleaning channel of the shell, and a control valve mounted in the output end of the cleaning channel of the shell.

### BACKGROUND OF THE INVENTION

1. Field of the Invention

The present invention relates to plastics processing technology and more particularly, to a molten plastic material filtration apparatus for plastic product fabrication that provides a wire mesh filter element backwash function to facilitate continuous production operation.

b 2. Description of the Related Art

During fabrication of a plastic product by means of a plastic extruder, filter means is usually use to remove impurities from the molten plastic material. Conventionally, a wire mesh filter element is attached to the output port of the plastic extruder to filtrate the molten plastic material. However, the open spaces in the wire mesh filter element tend to be blocked after a certain period of use. When this problem occurs, the wire mesh filter element must be cleaned or replaced with a new one. The wire mesh filter element may be washed or replaced with a new one by labor. Further, when a reclaimed plastic material is used for the production of a plastic product, the relatively high content of impurities will cause the wire mesh filter element to be blocked quickly. Frequently cleaning or replacing the wire mesh filter element will hinder the smoothness of the workflow.

### SUMMARY OF THE INVENTION

The present invention has been accomplished under the circumstances in view. It is the main object of the present invention to provide a molten plastic material filtration apparatus, which provides a wire mesh filter element backwash function, facilitating continuous production operation.

To achieve this and other objects of the present invention, a molten plastic material filtration apparatus comprises a shell and a filter. The shell has a cavity, and a feed channel, an outfeed channel and a cleaning channel respectively disposed in communication between the cavity and the space outside the shell. The filter is mounted in the cavity of the shell and rotatable relative to the shell, having a filter chamber and a plurality of through holes cut through the periphery thereof in communication with the filter chamber. A molten plastic material is fed through the feed channel into the inside of the shell, and then guided into the filter chamber of the filter and filtrated by the filter. After filtration through the filter, the molten plastic material is guided out of the shell through the outfeed channel. The molten plastic material in the filter chamber of the filter corresponding to the cleaning channel is forced to flow out of the filter into the cleaning channel subject to a pressure difference between the inside space and the outside space to back wash the wire mesh filter element of the filter.

### BRIEF DESCRIPTION OF THE DRAWINGS

FIG. 1 is a top view of a molten plastic material filtration apparatus in accordance with a first embodiment of the present invention.

FIG. 2 is a front view of the molten plastic material filtration apparatus in accordance with the first embodiment of the present invention.

FIG. 3 is a sectional view taken along line 3-3 of FIG. 2.

FIG. 4 is a sectional view taken in an enlarged scale along line 4-4 of FIG. 1.

FIG. 5 is an enlarged view of the shell shown in FIG. 3.

FIG. 6 is a sectional view taken along line 6-6 of FIG. 5.

FIG. 7 illustrates the outer appearance of the filter shown in FIG. 3.

FIG. 8 is a sectional view taken along line 8-8 of FIG. 7.

FIG. 9 is a sectional view taken along line 9-9 of FIG. 7.

FIG. 10 is an enlarged view of a part of FIG. 3.

FIG. 11 is a schematic drawing showing an operation status of the molten plastic material filtration apparatus in accordance with the first embodiment of the present invention.

FIG. 12 is similar to FIG. 4, showing the cleaning action of the locating groove of the filter.

FIG. 13 is a schematic structural view of a molten plastic material filtration apparatus in accordance with a second embodiment of the present invention.

FIG. 14 is a schematic structural view of a molten plastic material filtration apparatus in accordance with a third embodiment of the present invention.

FIG. 15 is a schematic structural view of a molten plastic material filtration apparatus in accordance with a fourth embodiment of the present invention.

FIG. 16 is a schematic drawing showing an alternate form of the fourth embodiment of the present invention.

FIG. 17 is a schematic drawing of the present invention, showing two molten plastic material filtration apparatuses connected in series according to the present invention.

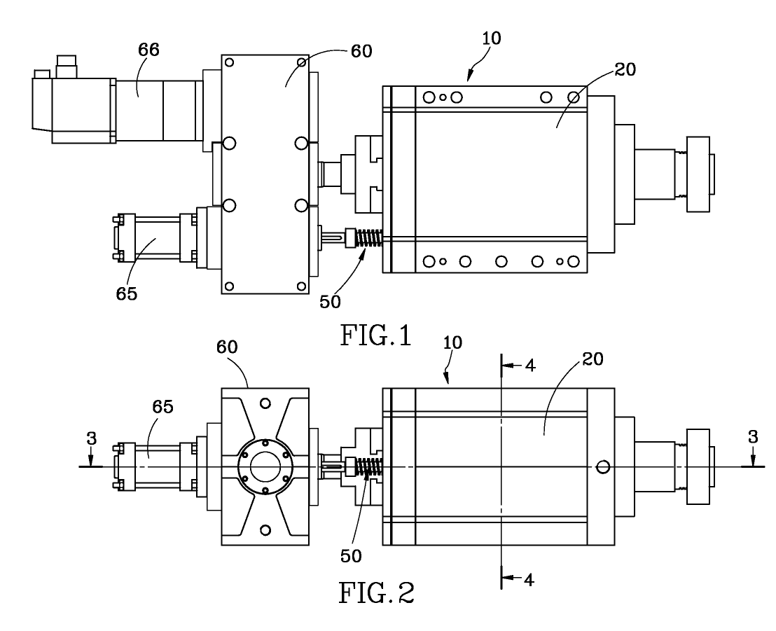

### DETAILED DESCRIPTION OF THE INVENTION

Referring to FIGS. 1˜11, a molten plastic material filtration apparatus 10 in accordance with a first embodiment of the present invention is shown comprising a shell 20, a filter 30, a guide member 40 and a scraper 50.

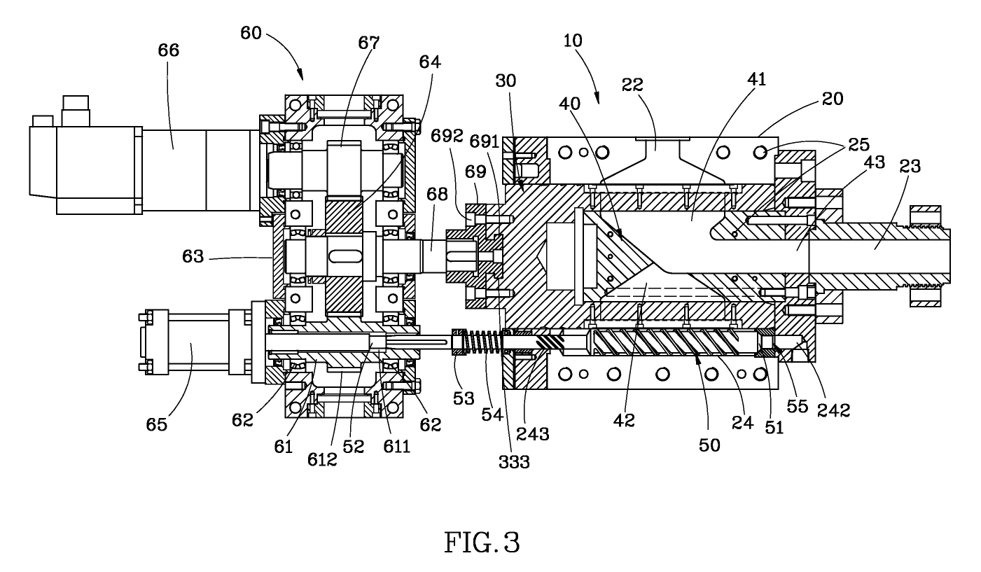

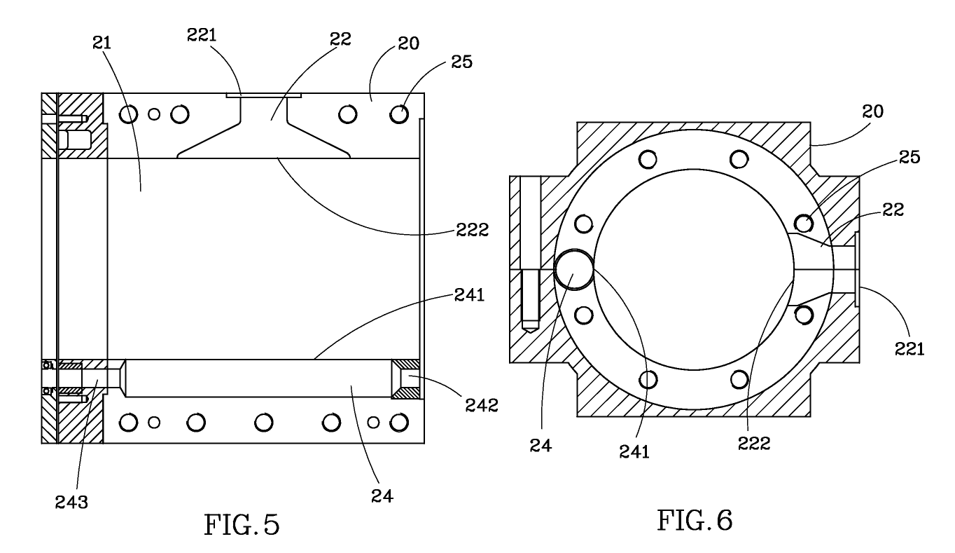

The shell 20, as shown in FIGS. 3˜6, has a cavity 21, and a feed channel 22, an outfeed channel 23 and a cleaning channel 24 respectively disposed in communication between the cavity 21 and the outside space. As shown in FIGS. 5 and 6, the cavity 21 has a cylindrical shape. The feed channel 22 has one end terminating in a circular inlet 221 that is located on the outside wall of the shell 20, and the other end terminating in a funnel-shaped outlet 222. The cleaning channel 24 is shaped like a cylinder, having a narrow longitudinal crevice 241 in communication with the cavity 21, a cleaning port 242 located on one end thereof and a pivot hole 243 located on the other end thereof. The shell 20 further has a plurality of accommodation holes 25 for accommodating electric heaters (not shown).

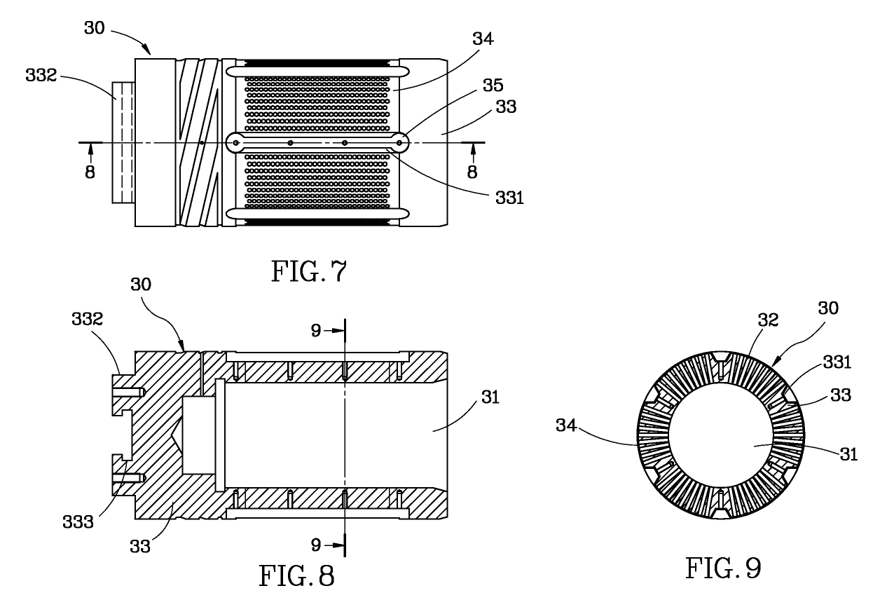

The filter 30, as shown in FIGS. 3, 4, 7, 8 and 9, is mounted in the cavity 21 of the shell 20 and rotatable relative to the shell 20 by an external force. The filter 30 comprises a cylindrical filter tube 33, a filter chamber 31 defined within the cylindrical filter tube 33, a plurality of through holes 32 radially cut through the tube wall of the cylindrical filter tube 33, at least one wire mesh filter element, for example, 6 wire mesh filter elements 34 mounted on the periphery of the cylindrical filter tube 33 over the through holes 32 where the wire mesh filter elements 34 have fine open spaces therein, and a plurality of packing strips 35 affixed to locating grooves 331 on the periphery of the filter tube 33 to hold down the wire mesh filter elements 34.

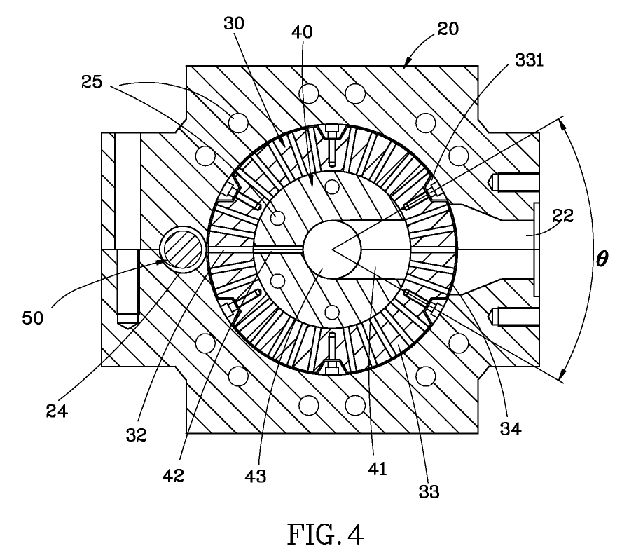

The guide member 40, as shown in FIGS. 3 and 4, is affixed to the shell 20 and received in the filter chamber 31 of the filter 30, having a feed-in guide passage 41 corresponding to the feed channel 22 of the shell 20, a cleaning guide passage 42 corresponding to the cleaning channel 24 of the shell 20 and an outfeed guide passage 43 corresponding to the outfeed channel 23 of the shell 20. The feed-in guide passage 41, the cleaning guide passage 42 and the outfeed guide passage 43 are connected to one another on the middle of the guide member 40. The feed-in guide passage 41 has funnel-shaped configuration matching the funnel-shaped outlet 222 of the feed channel 22 of the shell 20. The cleaning guide passage 42 is shaped like a narrow elongated funnel, having a longitudinal cross section corresponding to the size of the through holes 32 on the filter tube 33 of the filter 30, as shown in FIG. 4, to limit the flow rate of the molten plastic material flowing to the cleaning channel 24 of the shell 20.

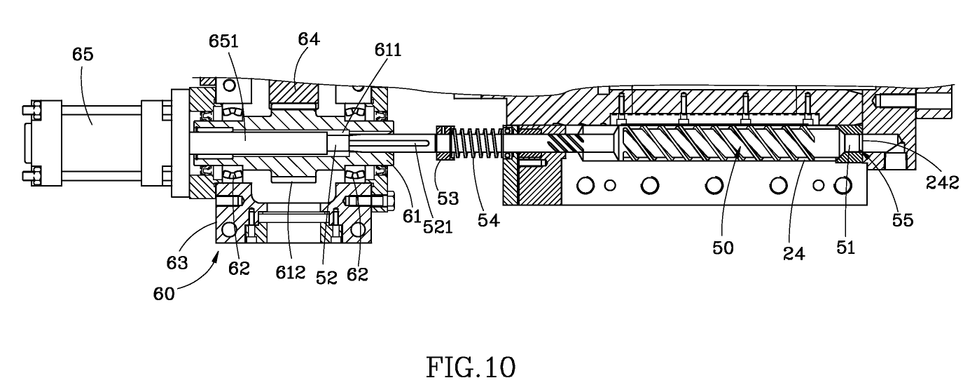

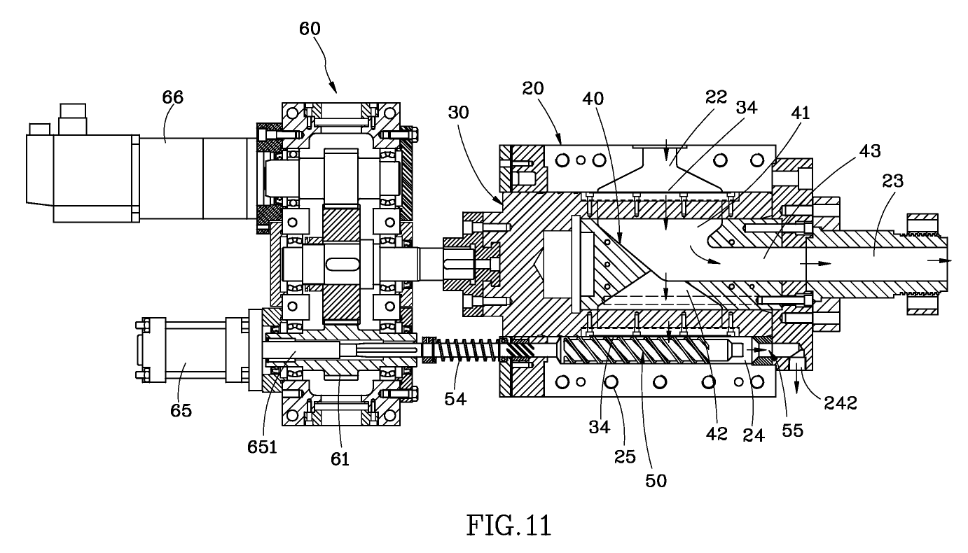

The scraper 50 is mounted in the cleaning channel 24 of the shell 20 for scraping the residual plastic material from the surface of the filter 30. As shown I FIG. 10, the scraper 50 is formed of a screw member, having one end, namely, the inner end 51 adapted for blocking the cleaning port 242 to constitute a control valve 55, the other end, namely, the outer end 52 extending out of the pivot hole 243 and a stop flange 53 extended around the periphery and disposed outside the shell 20. Further, a spring 54 is sleeved onto the shank of the screw member of the scraper 50 and stopped between the stop flange 53 and one end of the shell 20 to hold the control valve 55 in a normal open position (see FIG. 11). The outer end 52 of the scraper 50 is inserted into a transmission member 61 of a driving mechanism 60. The transmission member 61 is supported on two axle bearings 62 in a rack 63. The transmission member 61 has an axial hole 611, and a gear portion 612 extending around the periphery and meshed with and rotatable by a drive gear 64. The outer end 52 of the scraper 50 is coupled to the axial hole 611 of the transmission member 61 of a driving mechanism 60 by means of a key 521 and a keyway (not shown) so that the scraper 50 is rotatable by an external force and movable back and forth along the direction of its longitudinal axis. The rack 63 supports a pneumatic (hydraulic) cylinder 65 that has a cylinder rod 651 inserted into the axial hole 611 of the transmission member 61 and stopped against the outer end 52 of the scraper 50. When the pneumatic (hydraulic) cylinder 65 extends out the cylinder rod 651, the cylinder rod 651 will move the scraper 50 toward the cleaning port 242, causing the inner end 51 to stop the cleaning port 242 and to further close the valve 55. During the return stoke of the cylinder rod 651 of the pneumatic (hydraulic) cylinder 65, the scraper 50 is forced by the spring 54 to move in direction away from the cleaning port 242 so that the inner end 51 is moved away from the cleaning port 242 to open the valve 55. By means of gear transmission, the scraper 50 is rotated in the cleaning channel 24 of the shell 20. Further, by means of the functioning of the pneumatic (hydraulic) cylinder 65 and the spring 54, the scraper 50 is reciprocated in cleaning channel 24 of the shell 20 to close or open the valve 55. As shown in FIG. 3, the driving mechanism 60 comprises a motor 66 fixedly mounted on the rack 63, a pinion 67 mounted on the output shaft of the motor 66 and meshed with the drive gear 64 for rotating the drive gear 64 upon operation of the motor 66. The drive gear 64 has a gear shaft 68 extending out of the rack 63 and coupled to the cylindrical filter tube 33 through a connection member 69. The connection member 69 is fixedly connected to one end of the gear shaft 68 of the drive gear 64, having a dovetail tongue 691 coupled to a dovetail groove 333 on an outer end 332 of the cylindrical filter tube 33 outside the shell 20 and fixedly secured thereto with screw bolts 692.

Referring to FIG. 11, after having been fed into the feed channel 22 of the shell 20, the molten plastic material is filtrated by the wire mesh filter elements 34 of the filter 30 into the feed-in guide passage 41 of the guide member 40 and then guided by the outfeed guide passage 43 to the outside of the shell 20 via the outfeed channel 23. At the same time, a part of the molten plastic material goes through the cleaning guide passage 42 and then from the inside of the filter 30 to the outside of the filter 30 into the cleaning channel 24 to perform a reverse washing action. The valve 55 is normally closed to maintain the inside pressure of the shell 20, facilitating stable operation of the machine. The filter 30 can be rotated continuously or step by step at a predetermined interval. Alternatively, a pressure sensor can be installed in the feed channel 22 of the shell 20 to measure the pressure of the molten plastic material in the feed channel 22. When a pressure rise is measured, it means that filter blocking occurs. At this time, the shell 20 is automatically rotated through a predetermined angle, for example, an angle θ as shown in FIG. 4, to shift the feed channel 22 of the shell 20 into alignment with a next wire mesh filter element segment, i e., auto change of wire mesh filter element. The scraper 50 can be operated separately. Alternatively, the scraper 50 and the filter 30 can be operated together. According to this first embodiment, the scraper 50 and the filter 30 are operated together. When started up the motor 66 of the driving mechanism 60 to rotate the filter 30 through the set angle θ, the drive gear 64 drives the transmission member 61 to rotate the scraper 50, causing the scraper 50 to scrape the surface of the filter 30. At the same time, the cylinder rod 651 of the pneumatic (hydraulic) cylinder 65 is reciprocated rapidly, causing the scraper 50 to be reciprocated in the cleaning channel 24 of the shell 20 to close/open the valve 55. Therefore, reciprocating the scraper 50 in the cleaning channel 24 of the shell 20 causes the valve 55 to be opened or closed synchronously, enabling a limited amount of the molten plastic material to be expelled out of the cleaning channel 24 of the shell 20 through the cleaning port 242 under a predetermined control. When the inside pressure of the cleaning channel 24 is lowered, the molten plastic material will flow from the cleaning guide passage 42 to the cleaning channel 24 to back-wash the respective wire mesh filter element 34 that faces the cleaning guide passage 42, forcing impurities away from the respective wire mesh filter element 34. At the same time, the screw body of the scraper 50 removes the impurities. Except rotary scraping action, the scraper 50 is also reciprocated axially to scrape the respective wire mesh filter element 34, well cleaning the respective wire mesh filter element 34. Further, the valve 55 works as a relief valve. When the pressure of the molten plastic material in the shell 20 surpasses the force of the pneumatic (hydraulic) cylinder 65 and the spring 54, the valve 55 is opened to release the pressure automatically. Further, when the machine is shut down, the valve 55 is opened, facilitating cleaning work. According to this first embodiment, the shell 20 and the guide member 40 have respective accommodation holes 25 for accommodating electric heaters (not shown) that are controlled to keep the shell 20 and the guide member 40 within a predetermined temperature range, maintaining the plastic material in the molten status.

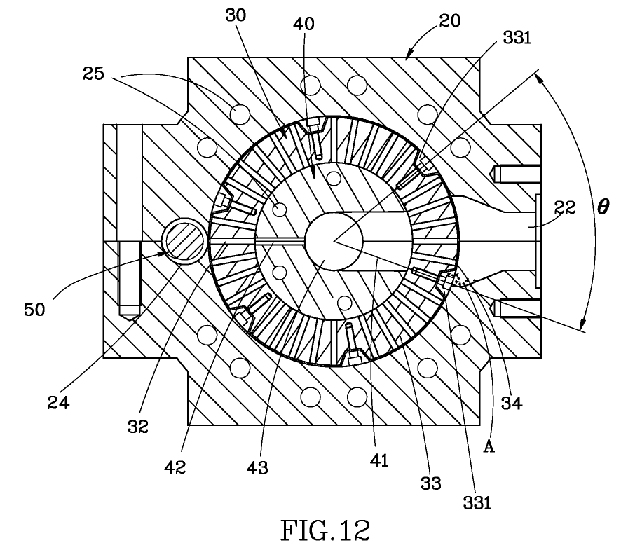

Referring to FIG. 12, the arrangement of the locating grooves 331 on the periphery of the filter tube 33 facilitates installation of the wire mesh filter elements 34 and performance of a cleaning work. When the wire mesh filter elements 34 that faces the feed channel 22 of the shell 20 is blocked, the filter 30 is rotated through an angle θ. At this time, greater impurity particles are stopped by the peripheral wall of the shell 20 and not moved with the wire mesh filter elements 34. Thus, greater impurity particles that are stopped by the peripheral wall of the shell 20 are gathered in the bottom side inside the feed channel 22 of the shell 20 (see the reference sign A). When one locating groove 331 is shifted to the feed channel 22 subject to a rotary motion of the filter 30, these greater impurity particles A are forced into the locating groove 331 by back pressure and then carried by the locating groove 331 to the cleaning channel 24 of the shell 20 following rotation of the filter 30. When the internal pressure of the cleaning channel 24 of the shell 20 is reduced suddenly, these greater impurities A are forced to protrude out of the respective locating groove 331 subject to expansion of the molten plastic material, and are then removed by the scraper 50. Thus, the arrangement of the locating grooves 331 on the periphery of the filter tube 33 facilitates cleaning work. Further, when wishing to replace the wire mesh filter elements 34, shut down the machine, and then move the driving mechanism 60 backwards, and then remove the filter 30 from the shell 20, and then unfasten the screw bolts 692. Because of the design of the dovetail groove 333, the filter 30 can be lifted for a replacement. After removal of the used filter 30, a new filter 30 is installed in the shell 20. After installation of the new filter 30, the production can be started again. This filter replacement operation is quick and simple, and the duration of the machine shutdown period is just ten and more minutes.

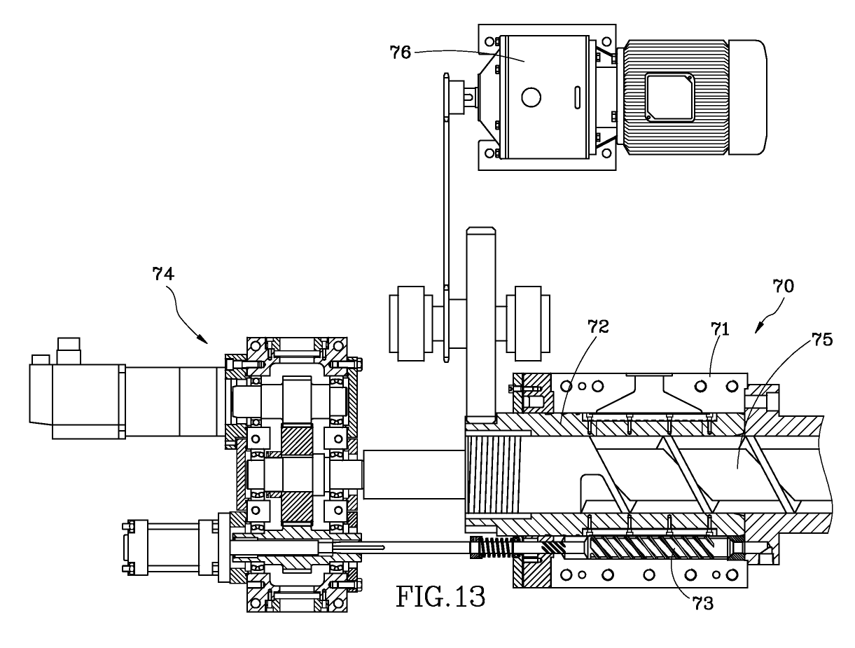

FIG. 13 shows a molten plastic material filtration apparatus 70 in accordance with a second embodiment of the present invention, which comprises a shell 71, a filter 72, a scraper 73 and a driving mechanism 74. This second embodiment eliminates the aforesaid guide member. On the contrary, this second embodiment has a screw rod 75 mounted in the filter 72 and rotatable by the driving mechanism 74. Further, another driving mechanism 76 is provided for rotating the filter 72. The screw rod 75 is rotated in the filter 72 in a direction reversed to the direction of rotation of the filter 72, or in the same direction relative to the direction of rotation of the filter 72 but at a different speed to force the molten plastic material outwards and simultaneously to scrape the wire mesh filter elements of the filter 72. This embodiment is suitable for coarse filtration.

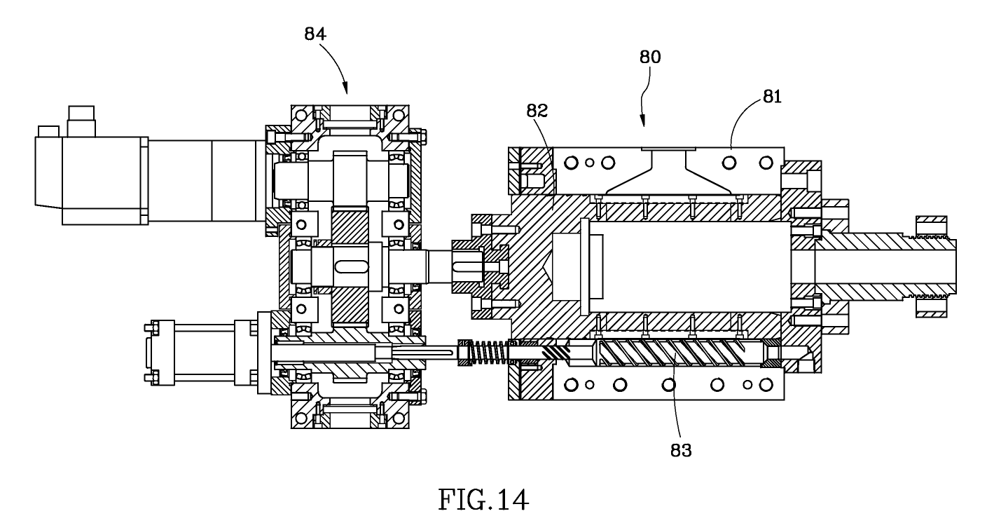

FIG. 14 shows a molten plastic material filtration apparatus 80 in accordance with a third embodiment of the present invention, which comprises a shell 81, a filter 82, a scraper 83 and a driving mechanism 84. This third embodiment is substantially similar to the aforesaid first embodiment with the exception that this third embodiment eliminates the aforesaid guide member. The molten plastic material filtration apparatus 80 in accordance with this third embodiment of the present invention is suitable for coarse filtration.

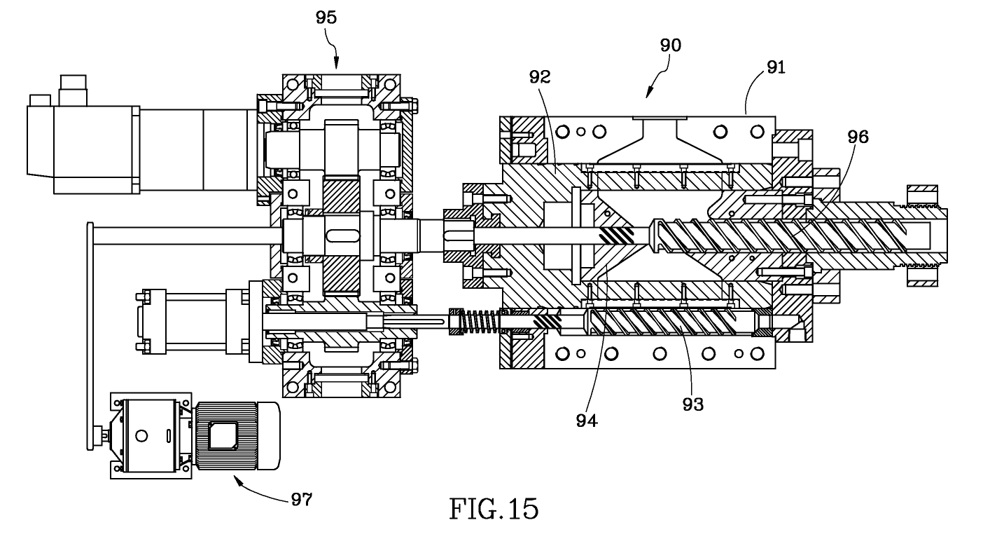

FIG. 15 shows a molten plastic material filtration apparatus 90 in accordance with a fourth embodiment of the present invention, which comprises a shell 91, a filter 92, a scraper 93, a guide member 94 and a driving mechanism 95. This fourth embodiment is substantially similar to the aforesaid first embodiment with the exception that the molten plastic material filtration apparatus 90 according to this fourth embodiment has a screw rod 96 mounted in the outfeed guide passage of the guide member 94 and connected to another driving mechanism 97. The screw rod 96 is adapted to force the molten plastic material outwards and to maintain the inside pressure of the guide member 94.

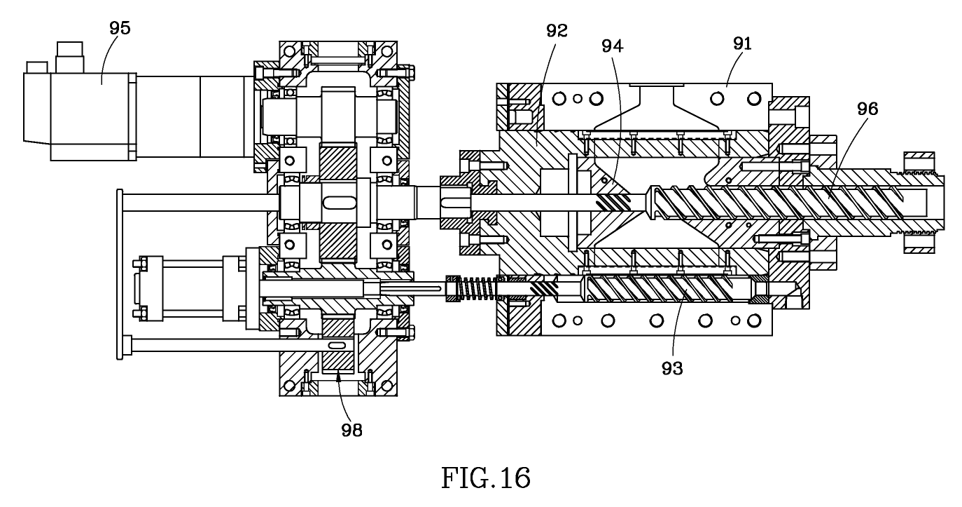

It is to be understood that the screw rod used in the aforesaid second embodiment or fourth embodiment can be rotated by a separate driving mechanism. Alternatively, the screw rod can be rotated by the same driving mechanism that is adapted to rotate the filter. In this case, a transmission mechanism is used to transfer the rotary driving force from the driving mechanism to the screw rod. FIG. 16 shows an alternate form of the fourth embodiment of the present invention in which a gear transmission mechanism 98 is coupled between the screw rod 96 and the driving mechanism 95 that is adapted to rotate the filter 92.

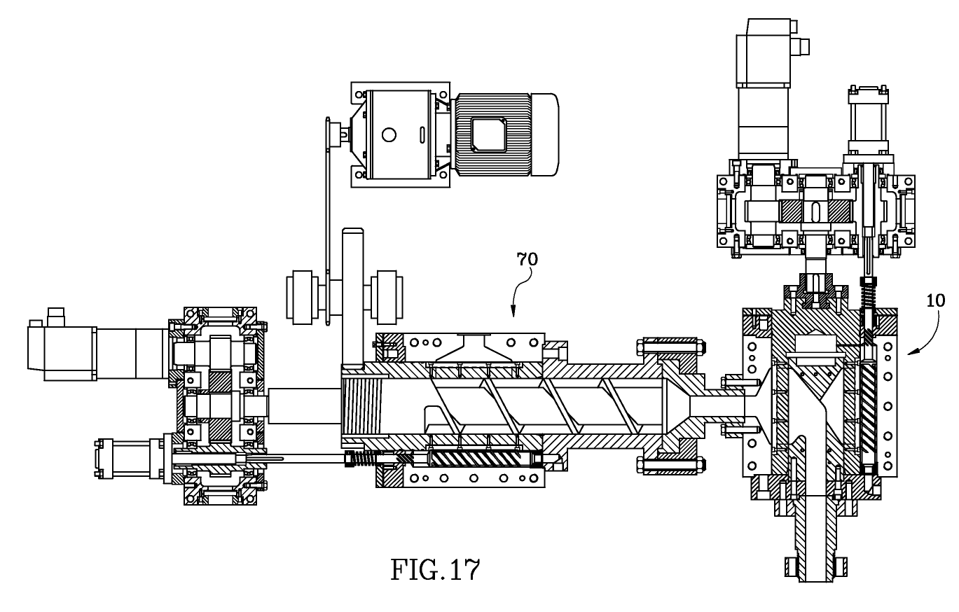

Referring to FIG. 17, a molten plastic material filtration apparatus 70 constructed according to the second embodiment of the present invention and a molten plastic material filtration apparatus 10 constructed according to the first embodiment of the present invention are connected in series for enabling the molten plastic material to be filtrated through coarse filtration and then fine filtration. Similarly, three or four molten plastic material filtration apparatus can be connected in series for application subject to user's different requirements.

What is claimed is:

1. A molten plastic material filtration apparatus, comprising:
a shell, said shell having a cavity, and a feed channel, an outfeed channel and a cleaning channel respectively disposed in communication between said cavity and the space outside said shell;
a filter mounted in said cavity of said shell and rotatable relative to said shell by an external force, said filter having a filter chamber and a plurality of through holes cut through the periphery thereof in communication with said filter chamber; and
a guide member affixed to said shell and positioned in said filter chamber of said filter, said guide member having a feed-in guide passage corresponding to said feed channel of said shell, a cleaning guide passage corresponding to said cleaning channel of said shell and an outfeed guide passage corresponding to said outfeed channel of said shell.

2. The molten plastic material filtration apparatus as claimed in claim 1, further comprising a control valve mounted in said cleaning channel and controllable to close/open said cleaning channel.

3. The molten plastic material filtration apparatus as claimed in claim 2, further comprising a scraper mounted in said cleaning channel and adapted to remove the residual plastic material from the surface of said filter.

4. The molten plastic material filtration apparatus as claimed in claim 3, wherein said scraper is movable relative to said filter by an external force.

5. The molten plastic material filtration apparatus as claimed in claim 4, wherein said cleaning channel of said shell has an elongated shape; said scraper has an elongated shape and is rotatable in said cleaning channel by an external force.

6. The molten plastic material filtration apparatus as claimed in claim 4, wherein said cleaning channel of said shell has an elongated shape; said scraper has an elongated shape and is axially reciprocatable in said cleaning channel by an external force.

7. The molten plastic material filtration apparatus as claimed in claim 4, wherein said cleaning channel of said shell has an elongated shape; said scraper has an elongated shape and is rotatable in said cleaning channel and axially reciprocatable in said cleaning channel.

8. The molten plastic material filtration apparatus as claimed in claim 3, wherein said cleaning channel of said shell has a cleaning port located on one end thereof; said scraper has a part adapted for closing said cleaning port to constitute said control valve.

9. The molten plastic material filtration apparatus as claimed in claim 4, wherein said scraper is shaped like a screw rod.

10. The molten plastic material filtration apparatus as claimed in claim 1, wherein said filter comprises a filter tube, said filter tube defining therein said filter chamber and carrying said through holes, and at least one wire mesh filter element wrapped about said filter tube.

11. The molten plastic material filtration apparatus as claimed in claim 10, wherein said filter tube has at least one locating groove for the mounting of said at least one wire mesh filter element.

12. The molten plastic material filtration apparatus as claimed in claim 11, wherein said filter further comprises at least one packing strip fastened to said at least one locating groove to secure said at least one wire mesh filter element in place.

13. The molten plastic material filtration apparatus as claimed in claim 1, wherein said shell has heater means mounted therein adapted to heat said shell to a predetermined temperature level.

14. The molten plastic material filtration apparatus as claimed in claim 1, further comprising a screw rod mounted in said outfeed guide passage of said guide member and rotatable relative to said guide member by an external force to guide a molten plastic material from said outfeed guide passage to the outside of said shell via said outfeed channel.

15. A molten plastic material filtration apparatus, comprising:
a shell, said shell having a cavity, and a feed channel, an outfeed channel and a cleaning channel respectively disposed in communication between said cavity and the space outside said shell;
a filter mounted in said cavity of said shell and rotatable relative to said shell by an external force, said filter having a filter chamber and a plurality of through holes cut through the periphery thereof in communication with said filter chamber; and
a screw rod mounted in said filter chamber of said filter and rotatable by an external force to move a molten plastic material, that is fed through said feed channel into said filter chamber of said filter, out of said shell through said outfeed channel.

16. The molten plastic material filtration apparatus as claimed in claim 15, further comprising a control valve mounted in said cleaning channel and controllable to close/open said cleaning channel.

17. The molten plastic material filtration apparatus as claimed in claim 16, further comprising a scraper mounted in said cleaning channel and adapted to remove the residual plastic material from the surface of said filter.

18. The molten plastic material filtration apparatus as claimed in claim 17, wherein said scraper is movable relative to said filter by an external force.

19. The molten plastic material filtration apparatus as claimed in claim 18, wherein said cleaning channel of said shell has an elongated shape; said scraper has an elongated shape and is rotatable in said cleaning channel by an external force.

20. The molten plastic material filtration apparatus as claimed in claim 18, wherein said cleaning channel of said shell has an elongated shape; said scraper has an elongated shape and is axially reciprocatable in said cleaning channel by an external force.

21. The molten plastic material filtration apparatus as claimed in claim 18, wherein said cleaning channel of said shell has an elongated shape; said scraper has an elongated shape and is rotatable in said cleaning channel and axially reciprocatable in said cleaning channel.

22. The molten plastic material filtration apparatus as claimed in claim 17, wherein said cleaning channel of said shell has a cleaning port located on one end thereof; said scraper has a part adapted for closing said cleaning port to constitute said control valve.

23. The molten plastic material filtration apparatus as claimed in claim 18, wherein said scraper is shaped like a screw rod.

24. The molten plastic material filtration apparatus as claimed in claim 15, wherein said filter comprises a filter tube, said filter tube defining therein said filter chamber and carrying said through holes, and at least one wire mesh filter element wrapped about said filter tube.

25. The molten plastic material filtration apparatus as claimed in claim 24, wherein said filter tube has at least one locating groove for the mounting of said at least one wire mesh filter element.

26. The molten plastic material filtration apparatus as claimed in claim 25, wherein said filter further comprises at least one packing strip fastened to said at least one locating groove to secure said at least one wire mesh filter element in place.

27. The molten plastic material filtration apparatus as claimed in claim 15, wherein said shell has heater means mounted therein and adapted to heat said shell to a predetermined temperature level.

28. A molten plastic material filtration apparatus, comprising:
a shell, said shell having a cavity, and a feed channel, an outfeed channel and a cleaning channel respectively disposed in communication between said cavity and the space outside said shell;
a filter mounted in said cavity of said shell and rotatable relative to said shell by an external force, said filter having a filter chamber and a plurality of through holes cut through the periphery thereof in communication with said filter chamber; and
a control valve mounted in said cleaning channel of said shell and controllable to close/open said cleaning channel.
